(19) United States
(12) Patent Application Publication
(10) Pub. No.: US 2014/0253264 A1
(43) Pub. Date: Sep. 11, 2014

(54) CIRCUIT BREAKER SLOT MOTOR

(71) Applicant: EATON CORPORATION, Cleveland, OH (US)

(72) Inventors: WILLIAM G. EBERTS, MOON TOWNSHIP, PA (US); KENNETH D. KOLBERG, MCKEES ROCKS, PA (US); BRIAN S. JANSTO, BEAVER FALLS, PA (US)

(73) Assignee: EATON CORPORATION, CLEVELAND, OH (US)

(21) Appl. No.: 13/787,898

(22) Filed: Mar. 7, 2013

(51) Int. Cl. H01H 33/38

(52) U.S. Cl. CPC H01H 33/38
USPC 335/16

(57) ABSTRACT

A two-piece slot motor housing assembly is provided. The slot motor housing assembly includes a first J-shaped body baying a lower, first end and a second, J-shaped body having a lower, first end. The first and second J-shaped bodies coupled to form a U-shaped assembly. The first J-shaped body first end overlaps the second J-shaped body first end.

### BACKGROUND OF THE INVENTION

1. Field of the Invention

The disclosed and claimed concept relates to circuit breakers and, more specifically, to a slot motor for a circuit breaker wherein the slot motor includes a multi-piece cover assembly.

2. Background Information

Circuit breakers, including molded case circuit breakers, have at least one pair of separable contacts. A first contact is fixed within the molded case housing and the other contact, the “movable contact,” is coupled to an operating mechanism. Both contacts are disposed on “arms” that are in electrical communication with either the line or load coupled to the circuit breaker. The operating mechanism is structured to more the movable contact between a first, open position wherein the movable contact is spaced from the fixed contact, and a second, closed position wherein the fixed and movable contacts are in contact and electrical communication. The operating mechanism may be operated manually or by the circuit breaker's trip mechanism. To enhance the speed of separation of the contacts, the contacts may be disposed within a slot motor.

A slot motor is a ring, i.e. loop-shaped device, or partial ring, made of magnetically permeable material which is disposed about, or partially about, the contacts and contact arms of a circuit breaker. When the circuit is live, an electrical arc may be drawn between the electrical contacts during separation. The electrical current interacts electromagnetically with the slot motor to induce a magnetic field in the magnetic material of the slot motor which in turns interacts with the separating contact arms to accelerate the contact opening process.

In one embodiment, slot motors generally have two assemblies, an upper assembly and a lower assembly. Both upper and lower assemblies include a housing assembly and a plurality of plates, or laminations, composed of the magnetically permeable material. The lower assembly is disposed below the fixed contact. As shown in FIG. 1, the upper assembly is an inverted U-shaped assembly having a housing assembly 1 and a plurality of plates 2. The “U-shape” includes a bight portion 3, i.e. a cross-portion, and two legs 4, 5. As used herein, “U-shaped” is interpreted broadly and includes an assembly having corners forming generally right angles, i.e. a squared U-shape. The upper slot motor is structured to be disposed over the movable contact wherein the tips of the upper assembly leg contact the lower assembly. The legs of the U-shaped upper assembly have an extended length to accommodate the path of travel of the movable contact arm. That is, the movable contact is disposed between the legs of the upper assembly and as the movable contact moves between the first, open position and the second, closed position, the movable contact moves from a position adjacent to the upper assembly bight to a position adjacent the tips of the legs. Accordingly, the legs must have a sufficient length to accommodate the path of travel of the movable contact arm. It should further be noted that the movable contact arm may, due to manufacturing tolerances, be free to shift a short distance laterally while moving. This design, i.e. a full loop, requires a significant amount of space in the circuit breaker housing assembly. Further, the circuit breaker housing assembly must have a height sufficient to accommodate the loop shaped slot motor.

In a full loop embodiment, the upper slot motor, i.e. the inverted U-shaped assembly included a U-shaped housing assembly. The upper slot motor housing assembly included an inner U-shaped member with forward and aft outwardly extending, depending sidewalls. Further, the tips of the tines included an outwardly extending depending sidewall that extended between the forward and aft sidewalls. Thus, the U-shaped magnetically permeable members could be moved longitudinally (in a direction parallel to the axis of the tines) into the upper slot motor housing assembly.

A disadvantage of such a U-shaped housing assembly was that, in view of the desired thinness of the U-shaped housing assembly walls, there were difficulties in molding the U-shaped housing assembly. For example, the tines of the U-shaped housing assembly tended to collapse toward each other. One solution to this problem was to create a two-piece housing, assembly having mirror image elements. These elements were coupled to each other with abutting surfaces. That is, the ends of the separate elements abutted each other at the interface. In such embodiments, the ends of the separate elements minimally overlapped, but, as used herein, surfaces with such a minimal amount of overlap shall be identified as “abutting surfaces.” Such abutting surfaces could be subject to electrical arcing therebetween, i.e. the arc could penetrate the interface. It is further noted that the distal ends of the upper slot motor were maintained in a spaced relationship by the stationary contact.

In another embodiment, the slot motor is a partial loop. That is, the slot motor extends under the fixed contact and upwardly on either side of the path of travel of the movable contact. Thus, the partial loop does not include an upper cross member and is shaped like an upright “U.” A slot motor that is a partial loop is, essentially, as effective as a full loop slot motor in that the accelerating forces are primarily generated near the point that the arc is generated, i.e. near the stationary contact. Thus, as a partial loop slot motor, i.e. a slot motor having an upright U-shape, does not have an upper cross-member, a partial loop slot motor can fit within a smaller circuit breaker housing assembly and takes up less space within such a circuit breaker housing assembly.

The housing assembly for a partial loop slot motor included a forward U-shaped wall with an axially depending sidewall. In this configuration, the housing assembly defined a pocket into which U-shaped magnetically permeable members could be placed. That is, the U-shaped magnetically permeable members were moved axially into the partial loop slot motor housing assembly. In this configuration, the partial loop slot motor housing assembly did not cover the of side of the magnetically permeable members, i.e. the side opposite the housing assembly forward wall. Tape, or a similar material, was used to protect the of side of the magnetically permeable members, it is noted that a two-piece upright U-shape housing assembly, wherein the tips of the U-shape housing assembly were not separated by the stationary contact would be subject to collapse. That is, one problem with a two-piece upright U-shape housing assembly would be that the pieces could pivot relative to each other.

There is, therefore, a need for a slot motor housing assembly for a partial loop slot motor, i.e. a slot motor having an upright U-shape, wherein the slot motor housing assembly is easy to manufacture. There is a further need for a partial loop slot motor housing assembly that resists arcing between a multiple piece housing assembly. There is a further need for a partial loop slot motor housing assembly that resists the collapse of the partial loop slot motor housing assembly. There is a further need for the improved slot motor to be compatible with existing circuit breaker housings.

### SUMMARY OF THE INVENTION

These needs, and others, are met by at least one embodiment of the disclosed concept which provides a two-piece slot motor housing assembly having an overlapping interface. As noted above, single piece housing assemblies have molding issues. Thus, the two-piece construction provides for a housing assembly that is easy to manufacture. The overlapping interface resists arcing between the multiple piece housing assembly. Further, each piece of the housing assembly is structured to be coupled to the arc chute housing. The support provided by the arc chute housing maintains the slot motor housing assembly elements in a spaced relationship. That is, the two pieces of the slot motor housing assembly do not collapse toward each other. It is noted that the stated problems are solved by the configuration, i.e. shape, of the two-piece slot motor housing assembly.

### BRIEF DESCRIPTION OF THE DRAWINGS

A full understanding of the disclosed and claimed concept can be gained from the following description of the preferred embodiments when read in conjunction with the accompanying drawings in which:

FIG. 1 is an isometric view of the prior art upper slot motor.

FIG. 2 is a cross-sectional side view of a circuit breaker.

FIG. 3 is an isometric exploded upward view of a circuit breaker.

FIG. 4 is an isometric downward view of a circuit breaker.

FIG. 5 is a detail isometric view of a stationary contact assembly.

FIG. 6 is an isometric view of a slot motor assembly housing assembly.

FIG. 7 is an isometric view of a slot motor assembly housing assembly first J-shaped body.

FIG. 8 is an isometric view of a slot motor assembly housing assembly second J-shaped body.

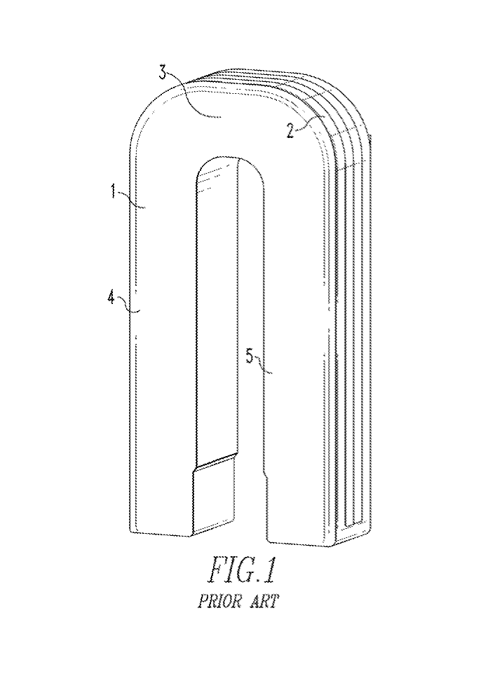

### DESCRIPTION OF THE PREFERRED EMBODIMENTS

The following directional terms apply to the slot motor assembly: the “longitudinal direction” extends in the direction of the longitudinal axis of the slot motor legs or tines, as described below. That is, the “longitudinal direction” is generally the vertical direction as shown in the Figures, The “lateral direction” extends in a direction generally perpendicular to the “longitudinal direction” and generally horizontally across both the motor legs or tines, as described below. The “axial direction” is generally perpendicular to both the “longitudinal direction” and the “lateral direction.” That is, the “axial direction” extends generally horizontally between the slot motor legs or tines, as described below. Further, with respect to the slot motor assembly, as used herein the “inner” side is the side adjacent the stationary contact, as described below, i.e. generally the inner side of the U-shaped assembly. Conversely, the “outer” side is the side disposed away from the stationary contact, as described below, i.e. generally the outer side of the U-shaped assembly.

As used herein, “coupled” means a link between two or more elements, whether direct or indirect, so long as a link occurs. An object resting on another object held in place only by gravity is not “coupled” to the lower object unless the upper object is otherwise maintained substantially in place. That is, for example, a book on a table is not coupled thereto, but a book glued to a table is coupled thereto.

As used herein, “directly coupled” means that two elements are directly in contact with each other.

As used herein, “fixedly coupled” or “fixed” means that two components are coupled so as to move as one while maintaining a constant orientation relative to each other. Similarly, two or more elements disposed in a “fixed relationship” means that two components maintain a substantially constant orientation relative to each other. As used herein, the word “unitary” means a component is created as a single piece or unit. That is, a component that includes pieces that are created separately and then coupled together as a unit is not a “unitary” component or body.

As used herein, “associated” means that the identified components are related to each other, contact each other, and/or interact with each other. For example, an automobile has four tires and four hubs, each hub is “associated” with a specific tire.

As used herein, “engage,” when used in reference to gears or other components having teeth, means that the teeth of the gears interface with each other and the rotation of one gear causes the other gear or other component to rotate/move as well. As used herein, “engage,” when used in reference to components not having teeth means that the components are biased against each other.

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

As used herein, “correspond” indicates that two structural components are similar in size, shape or function. With reference to one component being inserted into another component or into an opening in the other component, “corresponding ” means components are sized to engage or contact each other with a minimum amount of friction. Thus, an opening which corresponds to a member is sized slightly larger than the member so that the member can pass through the opening with a minimum amount of friction. This definition is modified if the two components are said to fit “snugly” together. In that situation, the difference between the size of the components is even smaller whereby the amount of friction increases. If one or more components are resilient, a “snugly corresponding” shape may include one component, e.g. the component defining the opening being smaller than the component inserted therein. Further, as used herein, “loosely correspond” means that a slot or opening is sized to be larger than an element disposed therein. This means that the increased size of the slot or opening is intentional and is more than a manufacturing tolerance.

As used herein, “more than minimally overlap” means that elements overlap by more than 0.02 inch.

As used herein, “effectively overlap” means that elements overlap by more than 0.05 inch.

As used herein, “efficiently overlap” means that elements overlap by more than 0.1 inch.

As used herein, “at” means on or near.

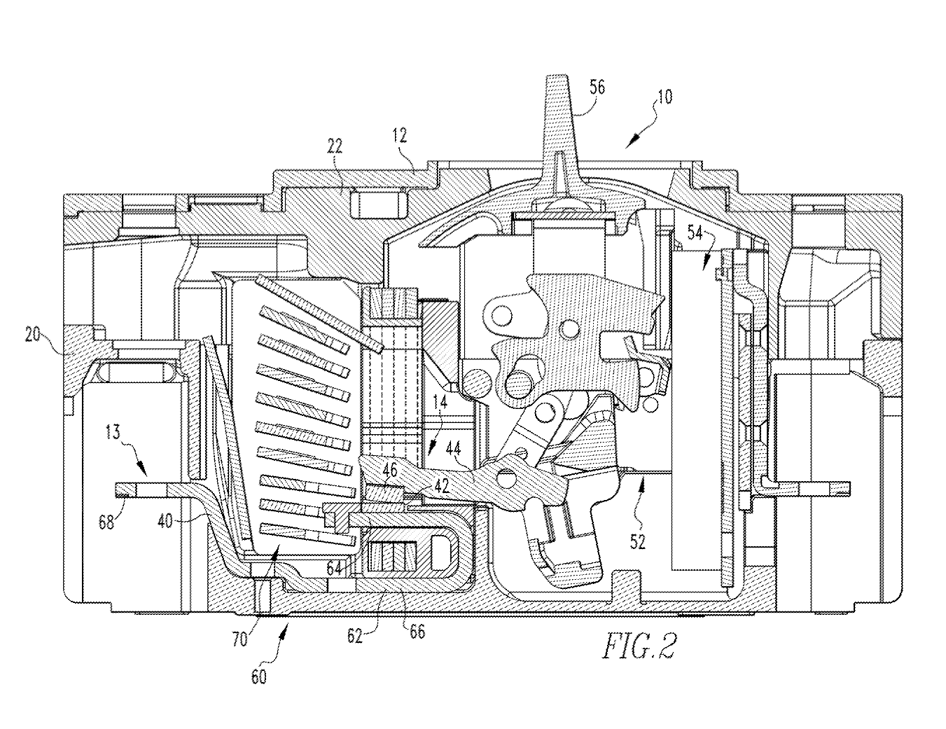

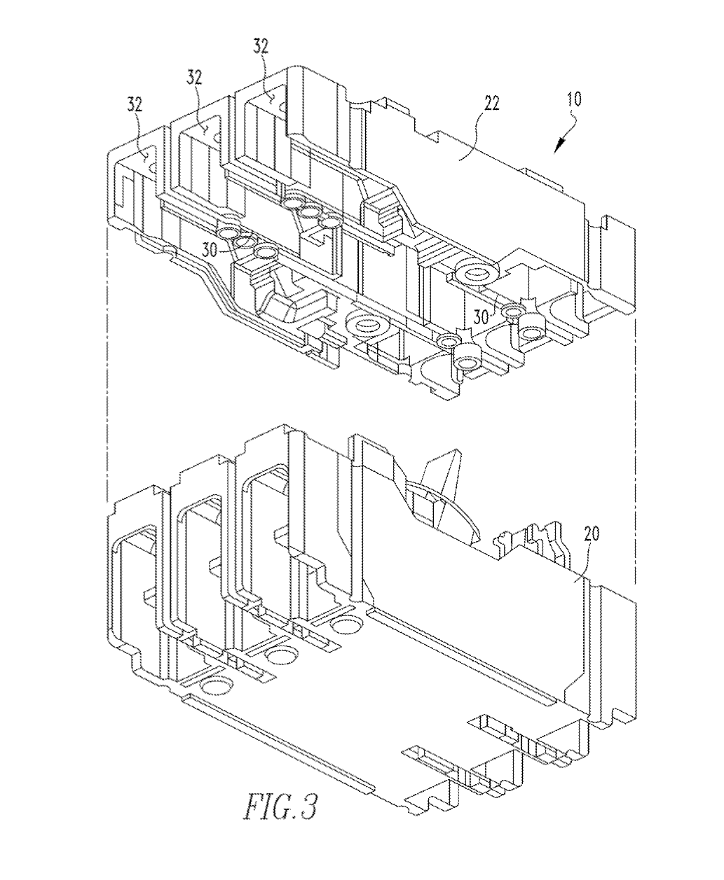

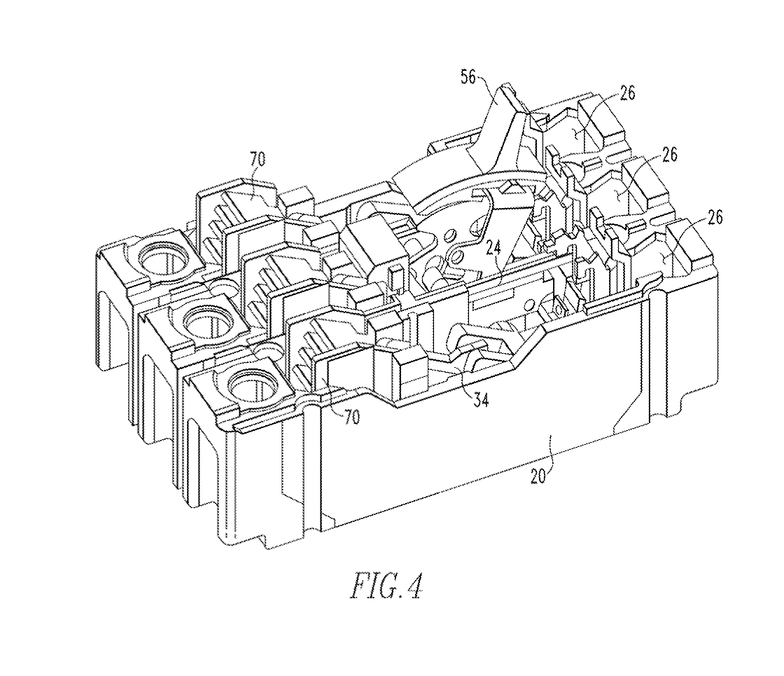

As shown in FIG. 2, a circuit breaker 10 includes a housing assembly 12 and a number of conductor assemblies 13 each including a pair of separable contacts 14. Typically, there is one conductor assembly 13 for each pole of the circuit breaker 10. An exemplary three pole circuit breaker 10 is shown in FIGS. 3 and 4 (base portion 20 only). The housing assembly 12 includes an elongated base portion 20 which is coupled to an elongated primary cover 22. The base portion 20 includes a plurality of internal walls 24 defining number of elongated cavities 26. In an exemplary embodiment, there is one cavity 26 for each pole of the circuit breaker 10. The primary cover 22 also includes a plurality of internal walls 30 which also define a number of elongated cavities 32. As noted above, in a three-pole circuit breaker 10 there are three base portion cavities 26 and three primary cover cavities 32. The base portion cavities 26 and primary cover cavities 32 extend generally parallel to each other and parallel to a longitudinal axis of the housing assembly 12. The base portion cavities 26 generally align with the primary cover cavities 32 so that when the primary cover 22 is coupled to the base portion 20, the base portion cavities 26 and the primary cover cavities 32 define a number of contact chambers 34 (FIG. 4), and in an exemplary embodiment with a three-pole circuit breaker 10, three contact chambers 34.

Each conductor assembly 13, shown in FIG. 2, includes substantially similar elements and, as such, only one conductor assembly 13 will be described. Each conductor assembly 13 includes a stationary conductor 40, a stationary contact 42, a movable conductor 44, and a movable contact 46. It is noted that only a portion of the current path along the movable conductor is shown. The stationary contact 42 is coupled to, and in electrical communication with, the stationary conductor 40. In an exemplary embodiment, the stationary contact 42 is directly coupled to the stationary conductor 40. The movable contact 46 is coupled to, and in electrical communication with, the movable conductor 44. In an exemplary embodiment, the movable contact 46 is directly coupled to the movable conductor 44. The movable contact 46, and more specifically, the movable conductor 44, is coupled to an operating mechanism 52. The operating mechanism 52 is structured to move the movable contact 46 between a first, open position (not shown) wherein the contacts 14 are separated, and a second, closed position (shown) wherein the contacts 14 are in electrical communication. The operating mechanism 52 is coupled to a trip mechanism 54 (shown schematically) and a handle 56. Thus, the operating mechanism 52 may be actuated manually by the handle 56, or, actuated in response to an over-current condition by the trip mechanism 54.

The stationary conductor 40 and stationary contact 42 are also part of a stationary contact assembly 60, shown in FIG. 5. The stationary contact assembly 60 further includes an arc chute assembly 70 and a slot motor assembly 80. The stationary conductor 40 is, in an exemplary embodiment, an elongated body 62 including a first end 64, a medial portion 66, and a second end 68. The stationary conductor body first end 64 is curled over the stationary conductor body medial portion 66 with a space or gap between the stationary conductor body first end 64 and the stationary conductor body medial portion 66. That is, the stationary conductor body medial portion 66 includes a planar portion 65 and an arcuate portion 67. The arcuate portion 67 extends over an arc of at least ninety degrees and, as shown, in one embodiment over an arc of about one hundred and eighty degrees. As shown, in one embodiment the stationary conductor body first end 64 is a planar member that extends in a plane generally parallel to the stationary conductor body medial portion planar portion 65.

The arc chute 70 includes a first lateral side planar member 72, a second lateral side planar member 74 and a number of conductive plates 76. The conductive plates 76 are disposed in a spaced relation to each other and disposed between the arc chute first lateral side planar member 72 and the arc chute second lateral side planar member 74. The arc cute 70 is disposed over the stationary conductor body medial portion 66 adjacent the stationary conductor body first end 64. Arc chute 70 is structured to absorb and dissipate an arc created by separation of the contacts 14. Arc chute 70 is sized to correspond to, i.e. fit within, a contact chamber 34. That is, the spacing between the arc chute first lateral side planar member 72 and the arc chute second lateral side planar member 74 generally corresponds to the width of a contact chamber 34. In one embodiment, the width of the arc chute 70 loosely corresponds to the width of the contact chamber 34. Each arc chute lateral side planar member 72, 74 further includes an extension 78 that extends toward the stationary conductor body first end 64. The slot motor assembly 80 is a U-shaped assembly. As used herein, a “U-shaped” element includes a bight (or cross member) and two tines (or legs). Further, as used herein, the tines of a U-shaped body extend generally perpendicular to, and in the same direction from, the bight. The transition between the bight and the tines may be curved, as shown in FIG. 5, or at generally right angles. The slot motor assembly 80 includes a number of magnetically permeable members 82 and a housing assembly 90. The slot motor assembly magnetically permeable members 82 each include a U-shaped body 84. The slot motor assembly magnetically permeable members 82 are disposed in a stack with each slot motor assembly magnetically permeable member 82 adjacent another slot motor assembly magnetically permeable member 82.

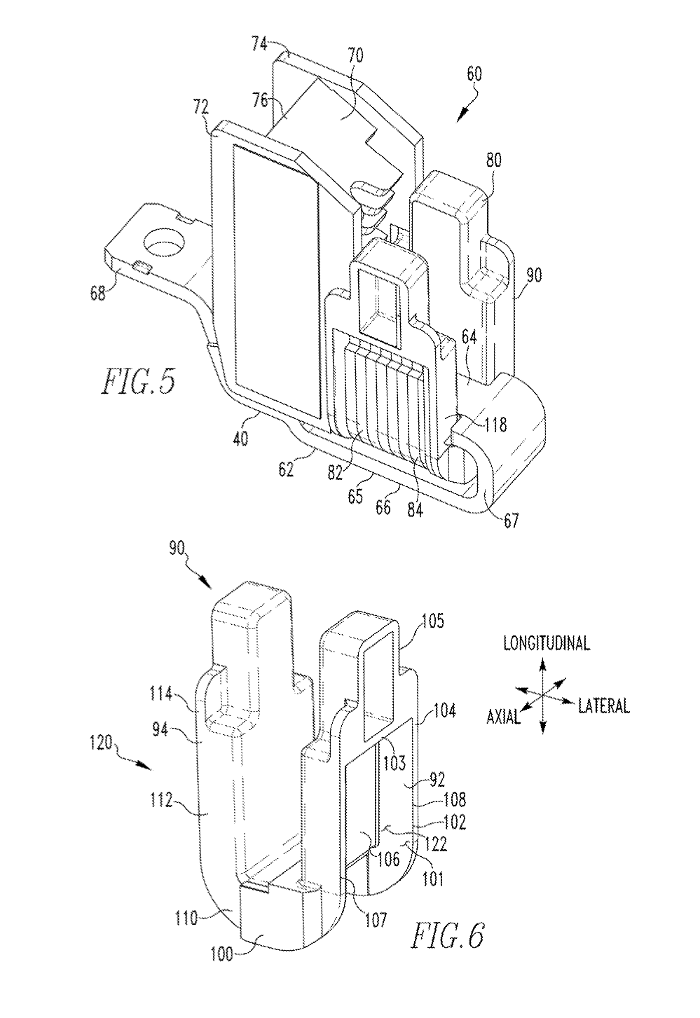

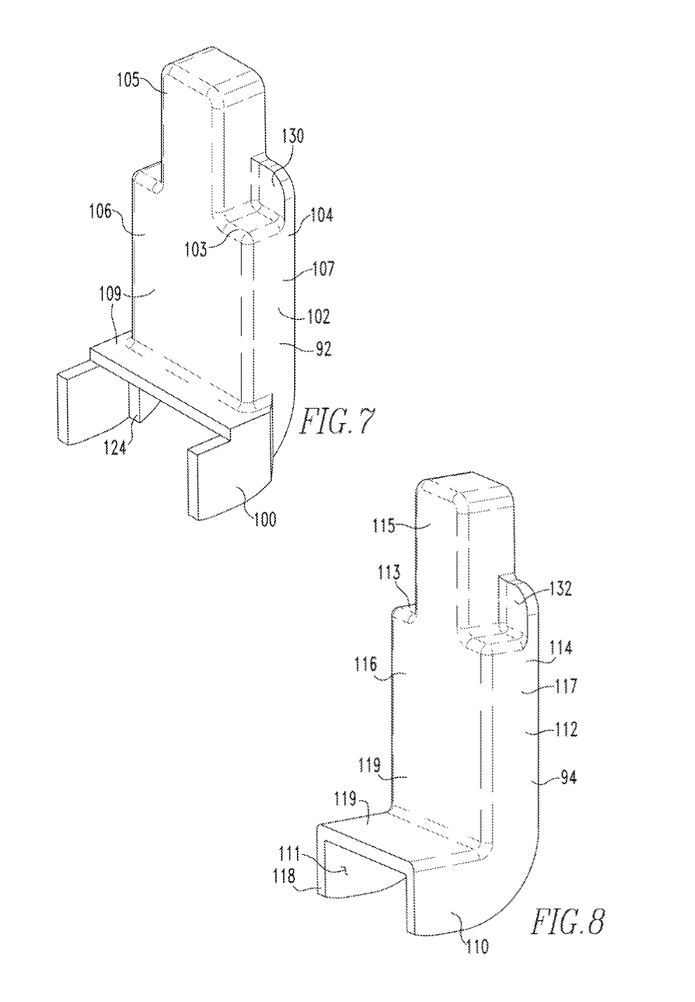

As shown in FIG. 6, the slot motor assembly housing assembly 90 includes a first J-shaped body 92 and a second, J-shaped body 94. The first J-shaped body 92 includes a lower first end 100, a medial portion 102 and an upper second end 104. The second, J-shaped body 94 includes a lower first end 110, a medial portion 112 and an upper second end 114. The first and second J-shaped bodies 92, 94 are structured to fit together in an overlapping manner. That is, the first J-shaped body 92, shown in FIG. 7, further includes an inner sidewall 106, a first depending sidewall 107 and a second depending sidewall 108 (FIG. 6). The first J-shaped body inner sidewall 106 is generally L-shaped and consists of two generally planar members 109. The first J-shaped body depending sidewalls 107, 108 are generally planar. The first J-shaped body depending sidewalls 107, 108 extend generally perpendicular to the first J-shaped body inner sidewall planar members 109. It is noted that the outer edge of the first J-shaped body depending sidewalls 107, 108 adjacent the vertex of the first “J”-shaped body inner sidewall 106 are curved thereby giving the first J-shaped body 92 its “J” shape. An end sidewall 103 extends between the first J-shaped body depending sidewalls 107, 108 at the first J-shaped body upper second end 104. As shown, the first J-shaped body end sidewall 103 may include a medial extension 105. In this configuration, the first J-shaped body 92 defines a cavity 101 on the outer side of the first J-shaped body 92. The first J-shaped body cavity 101 is sized to correspond to about half of the stack of magnetically permeable members 82. That is, the right half of the stack of magnetically permeable members 82 fits within the first J-shaped body cavity 101.

Similarly, the second J-shaped body 94, shown in FIG. 8 further includes an inner sidewall 116, a first depending sidewall 117 and a second depending sidewall 118.

The second J-shaped body inner sidewall 116 is generally L-shaped and consists of two generally planar members 119. The second J-shaped body depending, sidewalls 117, 118 (FIG. 5) are generally planar. The second J-shaped body depending sidewalk 117, 118 extend generally perpendicular to the second J-shaped body inner sidewall planar members 119. It is noted that the outer edge of the second J-shaped body depending sidewalls 117, 118 adjacent the vertex of the second J-shaped body inner sidewall 116 are curved thereby giving the second J-shaped body 94 its “J” shape. An end sidewall 113 extends between the second J-shaped body depending sidewalls 117, 118 at the second J-shaped body upper second end 114. As shown, the second J-shaped body end sidewall 113 may include a medial extension 115, in this configuration, the second J-shaped body 94 defines a cavity 111 on the outer side of the second J-shaped body 94. The second J-shaped body cavity 111 is sized to correspond to about half of the stack of magnetically permeable members 82. That is, as shown in FIG. 5, the left half of the stack of magnetically permeable members 82 fits within the second J-shaped body cavity 111.

The first J-shaped body 92 and the second, J-shaped body 94 may be coupled to form a U-shaped assembly 120 (FIG. 6). The U-shaped assembly 120 is generally symmetrical about a longitudinal-lateral plane. In this configuration, the first J-shaped body cavity 101 and the second J-shaped body cavity 111 form a continuous U-shaped cavity 122 that generally corresponds to the stack of magnetically permeable members 82. Further, the first J-shaped body first end 100 overlaps the second J-shaped body first end 110. That is, the first J-shaped body first end 100 has a greater cross-sectional area than the second J-shaped body first end 110. The first J-shaped body first end 100 generally corresponds to the second J-shaped body first end 110. Further, the first J-shaped body first end 100 may include a number of inwardly extending ledges 124 (FIG. 7). The first J-shaped body inwardly extending ledges 124 form an abutting surface. That is, when the second J-shaped body first end 110 is inserted into the first J-shaped body first end 100, the second J-shaped body first. end 110 will abut the first J-shaped body inwardly extending ledges 124.

The first J-shaped body first end 100 overlaps the second J-shaped body first end 110 in an axial direction, and, the first J-shaped body first end 100 further overlaps the second J-shaped body first end 110 in a longitudinal direction. That is, the first J-shaped body inner sidewall 106 overlaps the second J-shaped body inner sidewall 116, and, the first J-shaped body depending sidewalls 107, 108 overlap the second J-shaped body depending sidewalls 117, 118. More than minimally overlapping elements resist arc penetration. That is, it is the shape of the bodies, and the interface, that solves the problem of arcing between a multiple piece housing assembly. In one exemplary embodiment, the first J-shaped body first end 100 more than minimally overlaps the second J-shaped body first end 110. Resistance to arc penetration is improved if the overlap is more substantial. Accordingly, in another exemplary embodiment, the first J-shaped body first end 100 effectively overlaps the second J-shaped body first end 110. Further, in another exemplary embodiment, the first J-shaped body first end 100 efficiently overlaps the second J-shaped body first end 110.

Each of the first and second J-shaped body second ends 104, 114 include a tab 130, 132 (respectively, and as shown in FIGS. 7 and 8) extending generally in an axial-longitudinal plane. Each tab 130, 132 extends above the associated end sidewall 103, 113. In an embodiment wherein the width of the arc chute 70 loosely corresponds to the width of the contact chamber 34, the arc chute lateral side planar member extensions 78 are disposed inside the first and second J-shaped bodies tabs 130, 132. That is, the arc chute first lateral side planar member 72 is disposed inside the first J-shaped body second end tab 130, and, the arc chute second lateral side planar member 74 is disposed inside second J-shaped body second end tab 132. In this configuration, the rigidity of the arc chute 70 helps maintain the spacing between the first and second J-shaped body second ends 104, 114. That is, the arc chute 70 resists the inward collapse of the U-shaped assembly 120.

When the stationary contact assembly 60 is assembled, the slot motor assembly 80 is disposed with the bight of the slot motor assembly 80 disposed in the gap between the stationary conductor body first end 64 and the stationary conductor body medial portion 66. The tines of the slot motor assembly 80 extend upwardly. Thus, as the movable contact 46 moves between the first and second positions, the movable contact 46 moves between the tines of the slot motor assembly 80. An arc than forms during separation of the contacts 14 is not likely to penetrate the slot motor assembly housing assembly 90 because the first and second J-shaped bodies 92, 94 more than minimally overlap at their interface.

While specific embodiments of the disclosed and claimed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed and claimed concept which is to be given the full breadth of the claims appended and any and all equivalents thereof.

1. (canceled)

2. The slot motor housing assembly of claim 3 wherein:
said first J-shaped body first end overlaps said second J-shaped body first end in a longitudinal direction.

3. A slot motor housing assembly for a circuit breaker slot motor assembly, said slot member assembly including a number of magnetically permeable members, each magnetically permeable member including a U-shaped body, said slot motor housing assembly comprising:
a first J-shaped body having a lower, first end;
a second J-shaped body having a lower, first end;
said first J-shaped body includes an inner sidewall, a first depending sidewall, and a second depending sidewall, said first J-shaped body first depending sidewall and said first J-shaped body second depending sidewall extending generally perpendicular to said first J-shaped body inner sidewall;
said second J-shaped body includes an inner sidewall, a first depending sidewall, and a second depending sidewall, said second J-shaped body first depending sidewall and said second J-shaped body second depending sidewall extending generally perpendicular to said second J-shaped body inner sidewall;
said first J-shaped body first depending sidewall at said first J-shaped body first end overlaps said second J-shaped body first depending sidewall at said second J-shaped body first end in an axial direction;
said first J-shaped body second depending sidewall at said first J-shaped body first end overlaps said second J-shaped body second depending sidewall at said second J-shaped body first end in an axial direction;
said first and second J-shaped bodies coupled to form a U-shaped assembly; and
wherein said U-shaped assembly forms a continuous U-shaped cavity.

4. The slot motor housing assembly of claim 3 wherein said first J-shaped body first end includes a number of inwardly extending ledges.

5. The slot motor housing assembly of claim 3 wherein:
said first J-shaped body includes an upper, second end;
said second J-shaped body includes an upper, second end; and
said first J-shaped body second end and said second J-shaped body second end each include a tab extending generally in an axial-longitudinal plane.

6. The slot motor housing assembly of claim 3 wherein said U shaped assembly is generally symmetrical about a longitudinal-lateral plane.

7. (canceled)

8. The stationary contact assembly of claim 9 wherein:
said first J-shaped body first end overlaps said second J-shaped body first end in an axial direction; and
said first J-shaped body first end overlaps said second J-shaped body first end in a longitudinal direction.

9. A stationary contact assembly comprising:
a stationary conductor including an elongated body with a first end and a medial portion, said stationary conductor body first end curled over said stationary conductor body medial portion;
an arc chute assembly including a first lateral side planar member, a second lateral side planar member and a number of conductive plates, said conductive plates disposed in a spaced relation to each other and disposed between said arc chute first lateral side planar member and said arc chute second lateral side planar member;
said arc chute assembly disposed over said stationary conductor body medial portion adjacent said stationary conductor body first end;
a U-shaped slot motor assembly including a number of U-shaped magnetically permeable members and a housing assembly;
said slot motor magnetically permeable members each including a U-shaped body;
said slot motor housing assembly including a first J-shaped body having a lower, first end and a second, J-shaped body having a lower, first end;
said first J-shaped body includes an inner sidewall, a first depending sidewall, and a second depending sidewall, said first J-shaped body first depending sidewall and said first J-shaped body second depending sidewall extending generally perpendicular to said first J-shaped body inner sidewall;
said second J-shaped body includes an inner sidewall, a first depending sidewall, and a second depending sidewall, said second J-shaped body first depending sidewall and said second J-shaped body second depending sidewall extending generally perpendicular to said second J-shaped body inner sidewall;
said first J-shaped body first depending sidewall at said first J-shaped body first end overlaps said second J-shaped body first depending sidewall at said second J-shaped body first end in an axial direction;
said first J-shaped body second depending sidewall at said first J-shaped body first end overlaps said second J-shaped body second depending sidewall at said second J-shaped body first end in an axial direction;
said first and second J-shaped bodies slot motor housing assembly coupled to form a U-shaped assembly;
wherein said U-shaped assembly forms a continuous U-shaped cavity, said U-shaped cavity generally corresponding to said U-shaped magnetically permeable members;
said slot motor magnetically permeable members disposed in said U-shaped assembly; and
the bight of said U-shaped slot motor assembly disposed under said conductor body first end.

10. The stationary contact assembly of claim 9 wherein said first J-shaped body first end includes a number of inwardly extending ledges.

11. The stationary contact assembly of claim 9 wherein:
said first J-shaped body includes an upper, second end;
said second J-shaped body includes an upper, second end;
said first J-shaped body second end and said second J-shaped body second end each include a tab extending generally in an axial-longitudinal plane;
said arc chute first lateral side planar member disposed inside said first J-shaped body second end tab; and
said arc chute second lateral side planar member disposed inside said second J-shaped body second end tab.

12. The stationary contact assembly of claim 7 wherein said U-shaped assembly is generally symmetrical about a longitudinal-lateral plane.

13. (canceled)

14. The circuit breaker assembly of claim 15 wherein:
said first J-shaped body first end overlaps said second J-shaped body first end in an axial direction; and
said first J-shape body first end overlaps said second J-shaped body first end in a longitudinal direction.

15. A circuit breaker assembly comprising:
a housing assembly defining a number of contact chambers;
a number of conductor assemblies each having a pair of separable contacts;
each conductor assembly further including a stationary contact assembly, each stationary contact assembly including a stationary conductor, an arc chute assembly, and a U-shaped slot motor assembly;
each said stationary conductor including an elongated body with a first end and a medial portion, said stationary conductor body first end curled over said stationary conductor body medial portion;
each said arc chute assembly including a first lateral side planar member, a second lateral side planar member and a number of conductive plates, said conductive plates disposed in a spaced relation to each other and disposed between said arc chute first lateral side planar member and said are chute second lateral side planar member;
each said are chute assembly disposed over said stationary conductor body medial portion adjacent said stationary conductor body first end;
each said U-shaped slot motor including a number of U-shaped magnetically permeable members and a housing assembly;
each said motor magnetically permeable members each including a U-shaped body;
each said slot motor housing assembly including a first J-shaped body having a lower, first end and a second, J-shaped body having a lower, first end;
said first J-shaped body includes an inner sidewall, a first depending sidewall, and a second depending sidewall, said first J-shaped body first depending sidewall and said first J-shaped body second depending sidewall extending generally perpendicular to said first J-shaped body inner side-wall;
said second J-shaped body includes an inner sidewall, a first depending sidewall, and a second depending sidewall, said second J-shaped body first depending sidewall and said second J-shaped body second depending sidewall extending generally perpendicular to said second J-shaped body inner sidewall;
said first J-shaped body first depending sidewall at said first J-shaped body first end overlaps said second J-shaped body first depending sidewall at said second J-shaped body first end in an axial direction;
said first J-shaped body second depending sidewall at said first J-shaped body first end overlaps said second J-shaped body second depending sidewall at said second J-shaped body first end in an axial direction;
said first and second J-shaped bodies slot motor housing assembly coupled to form a U-shaped assembly;
wherein said U-shaped assembly forms a continuous U-shaped cavity, said U-shaped cavity generally corresponding to said U-shaped magnetically permeable members;
said slot motor magnetically permeable members disposed in said U-shaped assembly; and
the bight of said U-shaped slot motor disposed under said conductor body first end.

16. The circuit breaker assembly of claim 15 wherein said first J-shaped body first end includes a number of inwardly extending ledges.

17. The circuit breaker assembly of claim 15 wherein:
said first J-shaped body includes an upper, second end;
said second J-shaped body includes an upper, second end;
said first J-shaped body second end and said second J-shaped body second end each include a tab extending generally in an axial-longitudinal plane;
said arc chute first lateral side planar member disposed inside said first J-shaped body second end tab; and
said arc chute second lateral side planar member disposed inside said second J-shaped body second end tab.

18. The circuit breaker assembly of claim 15 wherein said U-shaped assembly is generally symmetrical about a longitudinal-lateral plane.
